(19) United States
(12) Patent Application Publication
(10) Pub. No.: US 2008/0204317 A1
(43) Pub. Date: Aug. 28, 2008

(54) SYSTEM FOR AUTOMATIC GEO-TAGGING OF PHOTOS

(76) Inventors: Joost Schreve, Palo Alto, CA (US); Christopher James McCarty, Redwood City, CA (US)

Correspondence Address: PERKINS COIE LLP, P.O. BOX 1208, SEATTLE, WA, 98111-1208, US

(21) Appl. No.: 12/038,702

(22) Filed: Feb. 27, 2008

Related U.S. Application Data
(60) Provisional application No. 60/891,924, filed on Feb. 27, 2007.

(51) Int. Cl. G01S 1/00

(52) U.S. Cl. 342/357.13

(57) ABSTRACT

The present invention contemplates a variety of improved techniques for geo-tagging of digital photo graphs. In some embodiments, this includes automatically updating photograph locations with a stored offset value.

### CLAIM OF PRIORITY

This application claims priority to U.S. Patent Application No. 60/891,924 entitled “System For Automatic Geo-Tagging Of Photos”, which was filed on Feb. 27, 2007, by Joost Schreve, the contents of which are expressly incorporated by reference herein.

### FIELD OF INVENTION

The present invention relates to geo-tagging of photos, i.e. referencing geographic coordinates (longitude, latitude, elevation) to a digital photo in order to specify where a photo was taken.

### BACKGROUND

The foregoing examples of the related art and limitations related therewith are intended to be illustrative and not exclusive. Other limitations of the related art will become apparent to those of skill in the art upon a reading of the specification and a study of the drawings.

People are taking more and more digital photos and it has become increasingly important to add context to these photographs. Allowing users to add location information is one way consumers are able to organize their photos and allows user to view the photos in their geographic context, thereby providing the viewer with a better appreciation of the experience. The commonly asked question: “where did you take this photo” is implicitly answered before the question is even asked.

Photo sharing websites have been developed which allow users to upload their photographs online and to store and/or distribute them. Some websites allow users to tag their photos with information manually, i.e. by a drag & drop mechanism. Manually tagging information of photos has a number of drawbacks. First, it takes a lot of effort by the user. When you want to tag 100s of photographs after a trip, it can take an hour or more to locate each photo. Second, the user may not remember exactly where each photo was taken, and therefore they may find it difficult or impossible to manually tag each photo. Third, this method may cause errors, even when the user remembers where the photo was taken, because the user may not succeed in tagging exactly the right location.

### SUMMARY OF THE INVENTION

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

The present invention contemplates a variety of improved methods and systems for automatic geo-tagging of digital photos. In some example embodiments, the system allows photos to be uploaded, organized, geo-stamped and shared with others. The system involves a computer accessing a server over the internet, the server able to provide an automatic geo-tagging webpage.

In some example embodiments, the user may upload global positioning system (GPS) data and photos onto a server using a light weight client application. Photos may be uploaded using a photo upload page on a website or imported from a third party photo sharing website. Each photo may be matched to a location. Users may select which data to include in the trip. Once users have specified which GPS track(s) and photos to include, users may be taken a new page showing the GPS data on a map.

In some example embodiments, if one or more of the photos are not matched correctly, the user may select photos and allow the user to place the photo in the correct location. After a photo a corrected, the user may be asked if the other photos should be repositioned relative to this one. If the user selects no, nothing happens. If the user selects yes, the nearest GPS trackpoint relative to the position of the photo is located and used to reposition the rest of the locations.

These and other advantages of the present invention will become apparent to those skilled in the art upon a reading of the following descriptions and a study of the several figures of the drawings.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 is a block diagram illustrating an example system which allows automatic location information tagging.

FIG. 2 depicts a flowchart for an example method of automatic geo-tagging digital photographs.

FIG. 3 depicts a flowchart for an example method of determining position information for automatic geo-tagging of digital photographs.

FIG. 4 depicts a flowchart for an example method of determining position information for automatic geo-tagging of digital photographs when photographs are not matched to locations.

FIG. 5 is a block diagram of an example data flow of information as photos are uploaded into the system.

FIG. 6 is a block diagram of an example data flow of global positioning system (GPS) information uploaded into the system.

FIG. 7 is a block diagram a of an example data flow in a creating a trip route map.

FIG. 8 is an illustration of an example interface for placing a digital photograph on a trip track.

FIG. 9 is an illustration of an example interface for updating the locations of other photographs.

FIG. 10 is an illustration of an example trip track with automatically placed digital photographs.

### DETAILED DESCRIPTION OF THE INVENTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

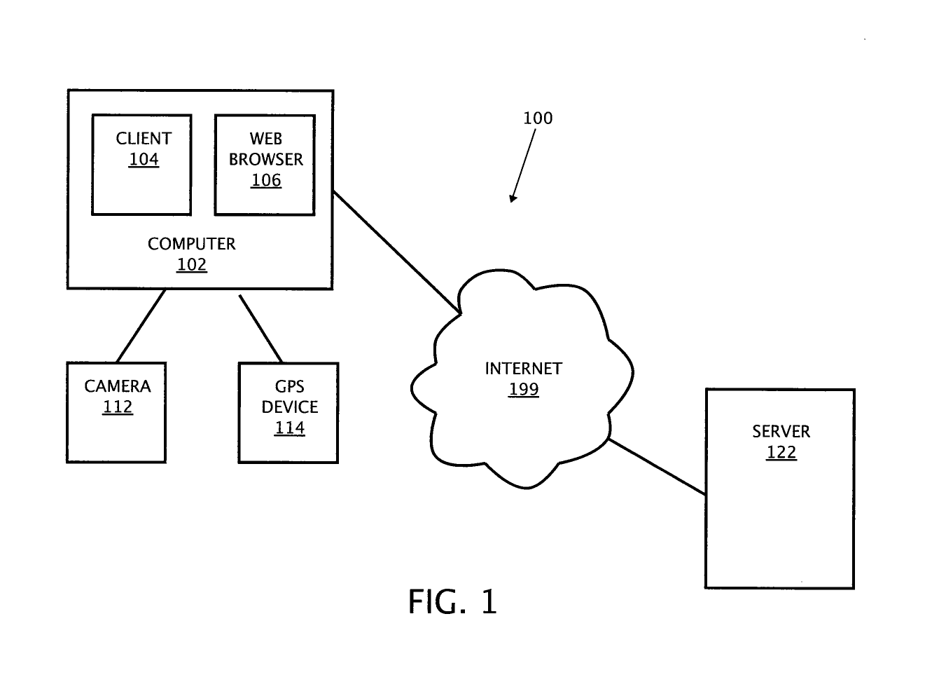

FIG. 1 is a block diagram illustrating a system 100 which allows automatic location information tagging. The system 100 includes a computer 102 running a client application module 104 and a web browser 106, a camera 112 and a global positioning system (GPS) device 114 coupled to the computer, and a server 122 coupled to the computer 102 through the internet 199.

The computer 102 may be any computer known or convenient. Some example of computers includes a Personal Computer (PC), a Power PC, a Personal Digital Assistant, etc. The computer 102 may be coupled to a camera 112 in a manner which allows photographs to be uploaded onto the computer 102. The computer may be coupled to a GPS enabled device 114 in a manner allowing trip information to be uploaded onto computer 102. The coupling to the computer 102 may be achieved in any manner known or convenient. For example, coupling may be by universal serial bus (USB), Firewire, transferring a memory card, etc.

The client application 104 may be a light weight client application running on the computer 102 and allows the coupled GPS device 114 and/or camera 112 to automatically upload information to the server 132 through the internet 199. The client application 104 may be implemented in any manner known or convenient. In some example embodiments, the client application 104 is not used and information from the camera 122 and GPS device 124 is uploaded through a web browser given an interface provided by the server 132.

The web browser 106 may be any browser known or convenient. Some example web browsers include Internet Explorer, Firefox, Opera, etc. The web browser 106 may connect to a web page provided by the server 122. The webpage provided by the server 122 may include a trip map showing a trip route and associated photographs. In some example embodiments, the computer 102 uploads information from the camera 112 and GPS device 114 through an interface displayed on the web browser 106 and provided by the server 122. In some example embodiments, the web browser 106 is omitted and the client 104 displays the trip map to the user.

In some example embodiments, the information uploaded from the GPS device 114 may be in the form of tracks and/or waypoints. Tracks are “breadcrumb trails” of substantially the path you took, as long as your GPS device received GPS signals. Tracks are represented as continuous lines. Waypoints are specific points of interest recorded on a GPS device while on the trail, or added to the trip route manually. In some example embodiments, the user may enter tracks and/or waypoints manually instead of uploading the information from a GPS device.

The server 122 may receive uploaded information from the computer 102 and store the information as a trip route. The server 122 may be any type of server known or convenient. The server 122 is configured to receive trip route information from users and provide maps showing the trip routes. The trip route may include GPS information and digital photographs received from the computer 102. The trip route may include pictures uploaded from the camera 112 and correlated with the GPS information uploaded by the GPS device 114, and the location of the picture intended to indicate where the user was when the picture was taken. The trip route may be stored in any format known or convenient.

In some example embodiments, the trip route may be displayed on a map by placing a line over a digital map, the line following substantially the path indicated by the GPS device 124. The pictures locations may be marked on the line at the where they were believed to be taken. In some example embodiments, the user may select from a variety of maps to display the trip route. For example, the user may select a satellite map, a 3-dimensional map, a normal road map, an elevation map, a hybrid road-satellite map, etc. The server 122 may also be configured to allow the user to add notes the to the trip route map. For example, the user may add text, audio, video, drawings, web links, etc. The notes may be placed on the map in a manner similar to the digital photographs, a marker designating where a note is located. Notes may also be added to the digital photographs.

In some example embodiments, the server 122 may be configured to receive direction from the computer 102 in order to edit the GPS information. This will be useful because some trips may have incorrect data or may include sections of little interest. The user may edit and trim their track through a user interface provided by the server 122. The user interface may be displayed through the client 104 or the web browser 106. In some example embodiments, the user can select which information to delete or modify by dragging a mouse over the points on the trip route map. The user may also be able to add additional section to the GPS information which may be missing or lost.

In some example embodiments, the server 122 may receive directions from the computer 102 to edit the position of the pictures in relation to the GPS information. The updated location information may update the locations of the rest of the pictures. The updated information may also be used in future trips in correlating the location of the pictures without input from the user.

In some example embodiments, the server 122 may store the pictures and GPS location information in a database. The database may be implemented in any form known or convenient. The user may be assigned a unique identification allowing them to sign in and retrieve the correct information from the database.

In some example embodiments, the system 100 may be used for mapping biking trips, hikes, road trips, vacations, etc. These trips can be visualized and shared. A user will record their trip route using a portable GPS system and may take photos as they are traveling. The trips may then be visualized a shared as trip route maps. In some example embodiments, the user may select whether the trip route map is shared to a select group of people, only registered users or is open to viewing by the public. Sharing may also be linked into networking sites (such as Myspace or Facebook) and allows your trip route map to be shared to your “friends” on those services. When you have multiple trips listed the most recent information may be on top.

In some example embodiments, the client application 104 allows you to log-in into the server 122, connect to your GPS device, and upload data directly to an account. In some example embodiments, the client application 104 is not required and the user is able to upload the information directly to a web page provided by the server 122.

In some example embodiment, a user can type in a trip type, trip date, and a description to help other users search. You can choose multiple map layers for your trips. The trips may be saved as private while they are being worked on and then made public when you are finished. The trips can also be downloaded into Google earth so they can be viewed in three dimensions.

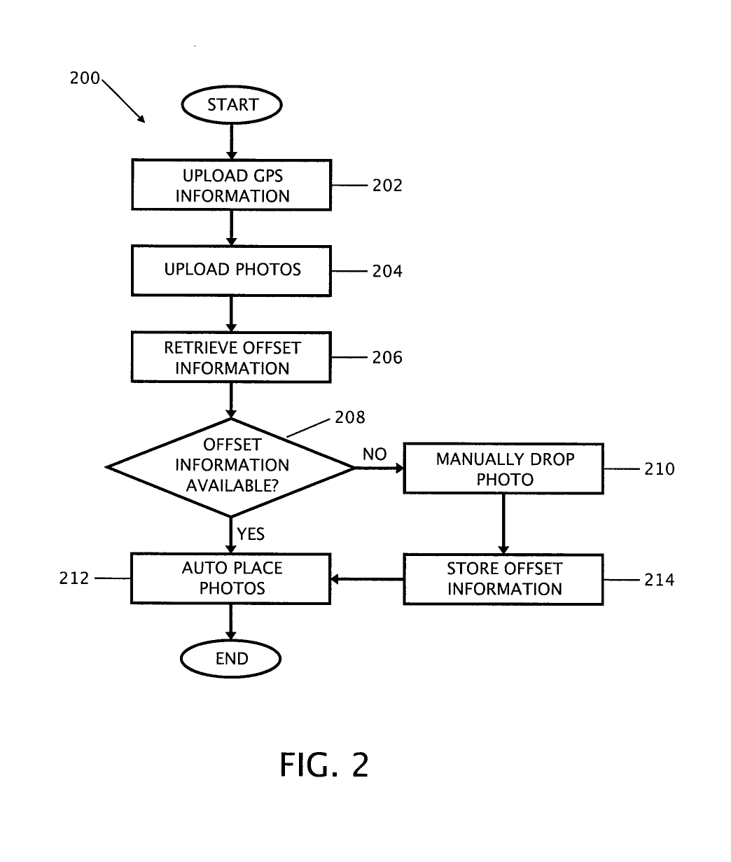

FIG. 2 depicts a flowchart 200 for an example method of automatic geo-tagging digital photographs. The process 200 includes a block 202, a block 204, a decisional node 206, a block 208, a block 210, a decisional node 212, a block 214, and a block 216. This method and other methods are depicted as serially arranged blocks. However, blocks of the methods may be reordered, or arranged for parallel execution as appropriate.

In block 202, a user uploads global positioning system (GPS) data to a website over the internet. The data may be uploaded in any format known or convenient. The data may be uploaded through a client running on the user's computer, a web interface, file transfer protocol (FTP), etc. The GPS data may be in any format known or convenient. For example, the information can be uploaded in a GPX file format. The GPS data may include trackpoints having location and time information during the trip.

In block 204, the user uploads digital photographs to a website over the internet. The digital photos may be in any format known or convenient. For example, the photos may be JPG, GIF, JIF, RAW, etc. The digital photos may include associated timestamp information which records the time the photographs was taken.

In block 206, saved offset information is retrieved for the user and/or camera and GPS combination. In some example embodiments, the information is retrieved from a database. The database may include offset information for any number of different users. In some example embodiments, the database will include multiple offsets for the same user depending on their camera and GPS device combination. In some embodiments, the user may store the offset locally to their computer. For example, a cookie could be saved with the information.

In decisional node 208, if time offset information was retrieved, the process may go to block 212, if no time offset information was retrieved then the process may go to block 210.

In block 210, the user may manually drag and drop a digital photograph to a desired location. Dragging and dropping the digital photograph may be done in any manner known or convenient. In some example embodiments, a map will be displayed to the user with the uploaded GPS information. The user may then select a digital photograph from a list and drag the photograph, or a marker representing the photograph to the desired location.

In block 212, the retrieved offset information is used to automatically place all or some of the uploaded digital photographs. The photos may be matched to the GPS information base on timestamp information included in the GPS information and the digital photograph file. In some example embodiments, a map will be displayed to the user with the uploaded GPS information. The locations of digital photographs will be marked on the map. The marking can be any manner known or convenient. For example, the locations can be marked by a camera icon, flags, circles, thumbnail photos, etc.

In block 214, the offset provided by the user manually placing a digital photograph is stored and may be user to automatically place photos in the future.

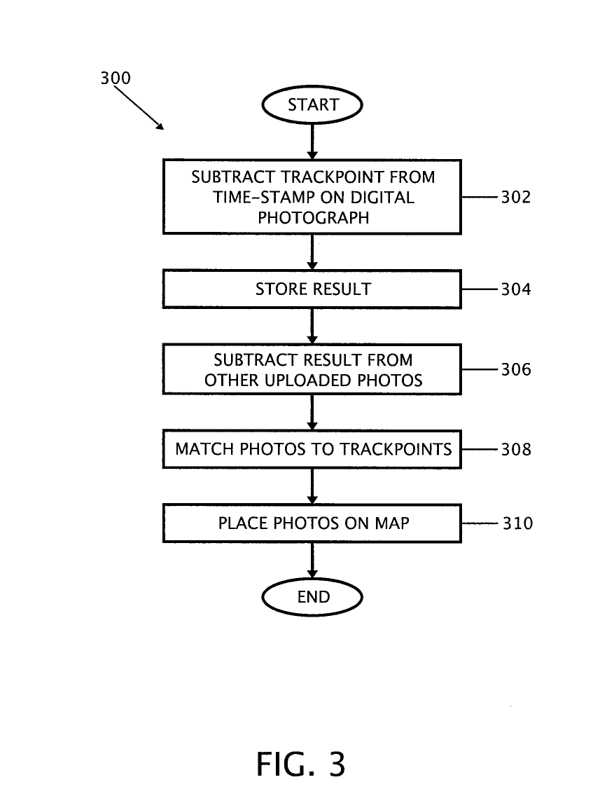

FIG. 3 depicts a flowchart 300 for an example method of determining position information for automatic geo-tagging of digital photographs. The process 300 includes a block 302, a block 304, a block 306, a block 308, and a block 310. This method and other methods are depicted as serially arranged blocks. However, blocks of the methods may be reordered, or arranged for parallel execution as appropriate.

In block 302, the time-stamp of a trackpoint included in uploaded global positioning system (GPS) information is subtracted from the timestamp of a photograph included in uploaded digital photographs and placed by the user.

In block 304, the result from block 302 is stored. In some example embodiments, the result will be stored and indexed a database.

In block 306, the result from block 302 is subtracted from the timestamp of the digital photographs included in a current trip. A current trip may include all uploaded photographs or may include only a subset of uploaded digital photographs. A subset of digital photographs may be selected by the user or may be automatically selected based on the particular digital photographs timestamp information.

In block 308, the timestamps of the uploaded digital photographs are compared to the timestamps of the uploaded trackpoints included in the current trip. Each digital photograph which falls within the interval of one of the tracks is matched to the trackpoint of which the timestamp has the closest match with the timestamp of said photo.

In block 310, the photos are associated with the closest trackpoint. The association may be done in any way known or convenient.

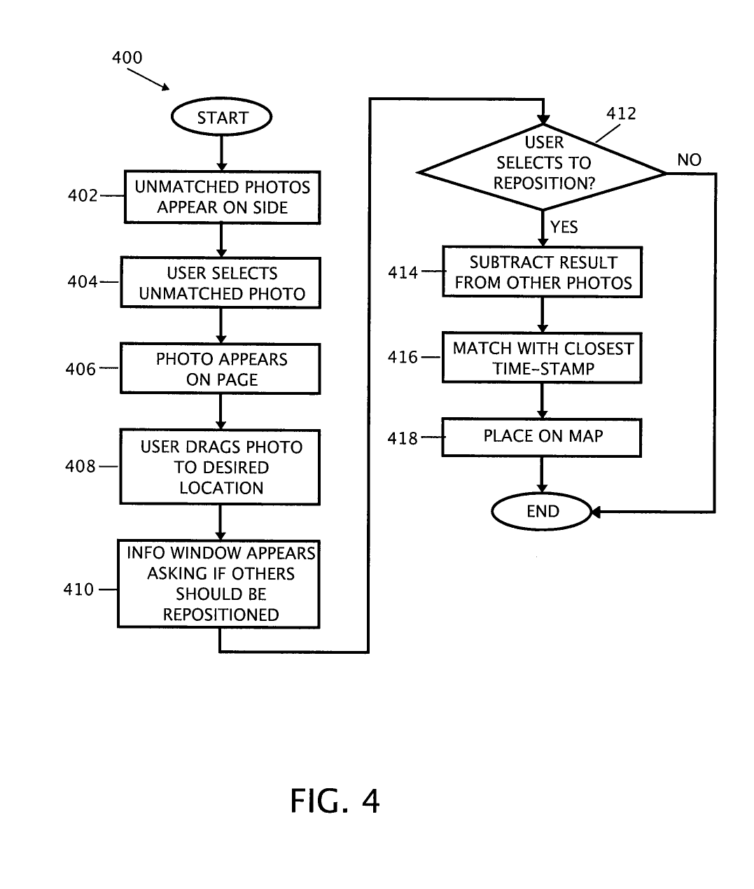

FIG. 4 depicts a flowchart 400 for an example method of determining position information for automatic geo-tagging of digital photographs when photographs are not matched to locations. The process 400 includes a block 402, a block 404, a block 406, a block 408, a block 410, a decisional node 412, a block 414, a block 416, and a block 418.

In block 402, photos that were not matched (i.e. the timestamp of the photo minus the specified offset does not fall within the time-interval of one of the global positioning system (GPS) tracks included in the trip) appear next to the map. In some example embodiments, the unmatched photos may have a button next to them which the user may select to specify the photos location on the map.

In block 404, the user selects an unmatched photo. The selection may be done using a graphical user interface or in any other manner known or convenient.

In block 406, after the digital photograph is selected the photograph or a marker representing the photograph appears in the middle of the map.

In block 408, the user drags the digital photograph to the desired location and releases the digital photograph.

In block 410, an infowindow appears asking the user if the other photographs should be repositioned relative to this one.

In decisional node 412, if the user selects not to reposition the other photographs the process ends. If the user selects to reposition the photographs, the process continues to block 414.

In block 414, the nearest GPS trackpoint relative to the position of the photo is located and the time-stamp of this trackpoint is subtracted from the timestamp of the photo and the resulting number is stored in the database.

In block 416, this resulting number of block 416 is subtracted from all other photos that are included in the current trip and the timestamps of all these photos are compared to the timestamps of all trackpoints included in the current trip.

In block 418, each photograph which falls within the interval of one of the tracks is matched to the trackpoint of which the timestamp has the closest match with the timestamp of said photo, and the photos are placed on the map.

In some example embodiments, the timestamp offset that was calculated will remain saved in the database. The next time the same user creates a trip with photos and GPS data, while using the same GPS device and photo camera with the same time settings, the photos may be automatically be placed without manually placing a first digital photograph.

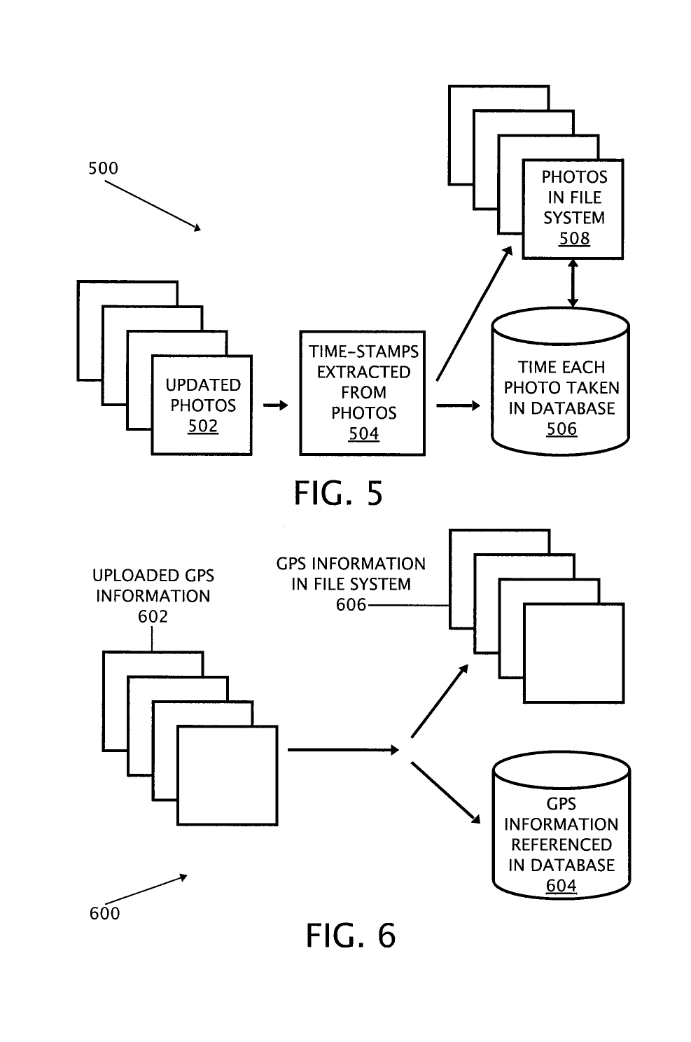

FIG. 5 is a block diagram of an example data flow 500 of information as photos are uploaded into the system. The data flow includes digital photographs 502, time stamp information 504, a database 506 and a file system 508.

As the user uploads digital photographs 502 into the time stamp information is extracted from the digital photographs 502. The timestamp information 504 may then be stored in the database 506. The photographs may then be stored in the file system 508.

The file system 508 may be any file system known or convenient. The database 506 may be any database known or convenient.

FIG. 6 is a block diagram of an example data flow 600 of global positioning system (GPS) information uploaded into the system. The GPS information 602 is uploaded. The GPS tracks and waypoints are stored in the database 604. The GPS information files are stored in the file system 606.

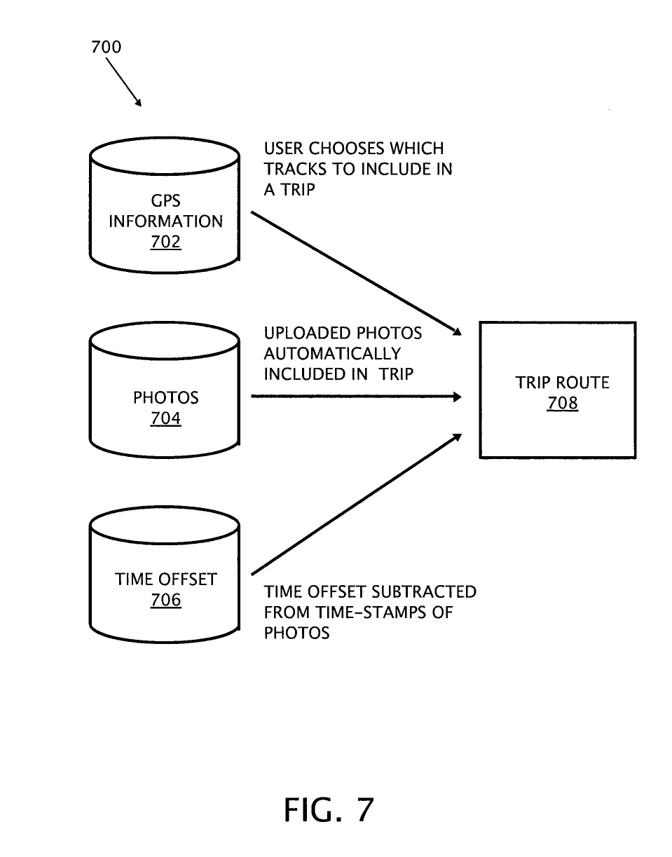

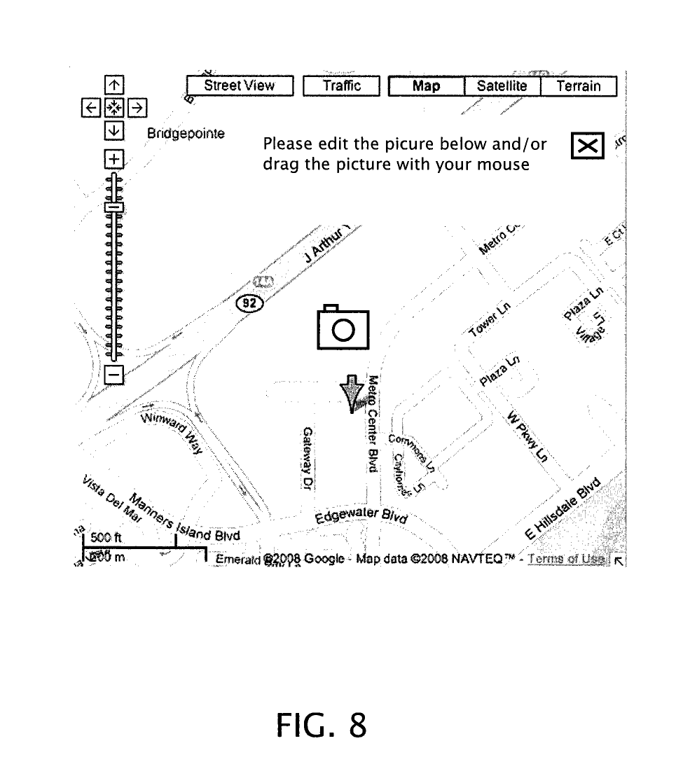

FIG. 7 is a block diagram a of an example data flow 700 in a creating a trip route map. Block 702 is track information which you have chosen to upload in a trip. Block 704 is photos which are uploaded and automatically included in a trip. Block 706 is time offsets which may be subtracted from the timestamps of photos. Block 708 is the information after the photo location is initially matched based on time stamps and time-offset.

In some example embodiments, multiple users may view the same track simultaneously and make comments. The users may also communicate over voice chat or instant messaging. In some example embodiments, a user may update a track in as the user is traveling. This may be accomplished by a wireless connection to the internet or by periodic uploading of the information while traveling. In some example embodiments, the tracks will allow other users to comment. For example, a user could place warnings or note changes which have occurred since the track was recorded. In some example embodiments, a search system may be included which allows users to search for tracks that are

FIG. 8 is an illustration of an example interface for placing a digital photograph on a trip track. The icon in the shape of the camera indicates the current location the user desires the digital photograph to be placed. In some example embodiments, the icon will start automatically in the middle of the trip route map and allow the user to adjust the icon to the desired location.

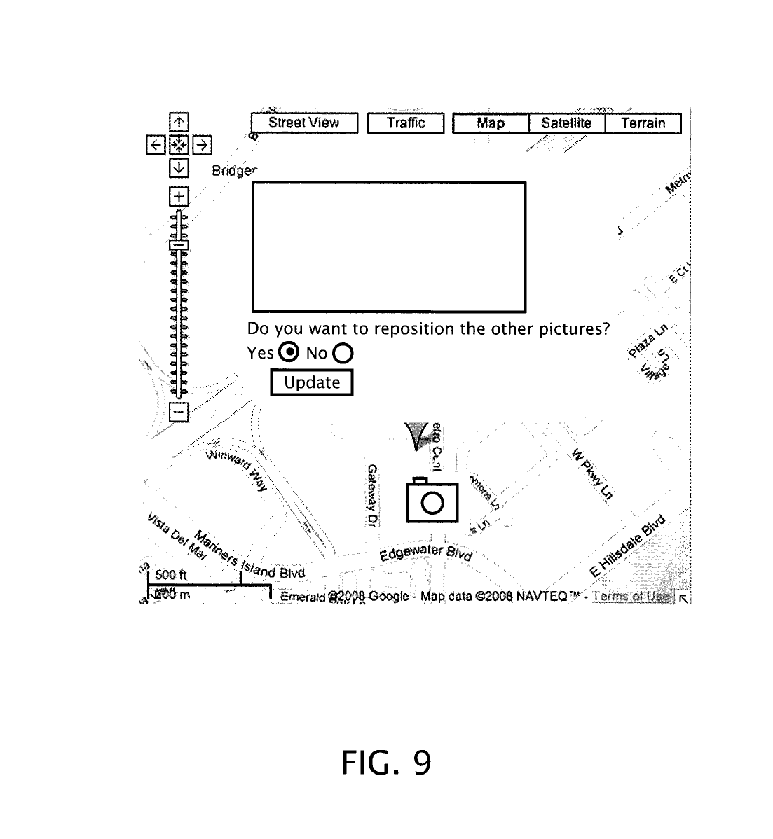

FIG. 9 is an illustration of an example interface for updating the locations of other photographs. After a digital photograph is dragged to the user's desired location, the user may be given the option to automatically layout or update other digital photographs.

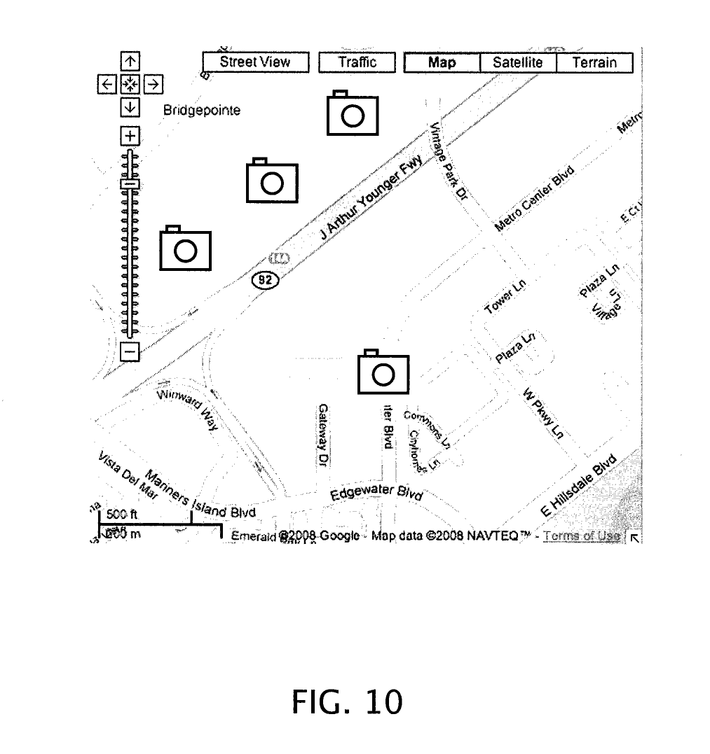

FIG. 10 is an illustration of an example trip route map with automatically placed digital photographs. If the user selects to place the other digital photographs they may placed automatically.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

As used herein, the term “embodiment” means an embodiment that serves to illustrate by way of example but not limitation.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

I claim:

1. A system comprising:
a network;
a computer;
a server coupled to the computer through the network; and
wherein, the server is configured to allow a user of the computer to upload global positioning system (GPS) information and digital photographs, the server is further configured to create a trip route map graphically displaying the GPS information and the location markers of digital photographs displayed on a digital map.

2. A system as recited in claim 1, wherein the computer executes a client process, the client process configured to allow the user to upload GPS information directly to the server.

3. A system as recited in claim 1, wherein the computer executes a web browser, the server configured to display a web page on the web browser, the web page including a graphical user interface allowing the user to upload digital photographs to the server.

4. A system as recited in claim 1, wherein the server is configured to automatically determine the location markers of the digital photographs using a saved offset value.

5. A system as recited in claim 1, wherein the server is configured to allow the user to select the placement of a location marker of one of the digital photographs, the placement of the location marker used to create an offset value, and the offset value used to automatically place the location markers of the other digital photographs.

6. A system as recited in claim 1, wherein the server is configured to allow the user to associate descriptive information with the trip route map, the descriptive information used to allow other users to search for the trip route map.

7. A system as recited in claim 6, wherein the descriptive information includes the location of the trip.

8. A system as recited in claim 1,
wherein the computer executes a client process, the client process configured to allow the user to upload GPS information directly to the server;
wherein the computer executes a web browser, the server configured to display a web page on the web browser, the web page including a graphical user interface allowing the user to upload digital photographs to the server;
wherein the server is configured to automatically determine the location markers of the digital photographs using a saved offset value; and
wherein the server is configured to allow the user to select the placement of a location marker of one of the digital photographs, the placement of the location marker used to create an offset value, and the offset value user to automatically place the location markers of the other digital photographs.

9. A method for creating a trip route comprising:
uploading global positioning system (GPS) information;
uploading digital photographs;
retrieving offset information;
if offset information is available, automatically associating the digital photographs with positions in the GPS information using the offset information;
if offset information is not available, prompting a user to manually associate on of the photographs with a position in the GPS information;
deriving offset information from the manually associated digital photograph;
storing the derived offset information;
automatically placing the rest of the photographs using the derived offset information.

10. A method as recited in claim 9 further comprising:
displaying the GPS information and associated photographs over a digital map.

11. A geo-tagging web server comprising:
a computer, the computer configured to connect to the internet and provide a webpage allowing the geo-tagging of photographs;
wherein, the computer is configured to store offset information for a user, computer configured to use the offset information to automatically associate digital photographs with positions on a trip route uploaded by the user.

12. A server as recited in claim 11, wherein the server is configured to receive global positioning system (GPS) information through a client on the user's computer.

13. A server as recited in claim 11, wherein the server is configured to receive digital photographs through a web browser on the user's computer.

14. A server as recited in claim 11, wherein the offset information configured to be subtracted from time stamp information included in the digital photographs.

15. A server as recited in claim 11, wherein the computer is configured to serve an interactive image of a trip route map including the trip route and representational markers of the associated photographs.

16. A server as recited in claim 15, wherein the computer is configured to allow the user to select from a plurality of different maps to be used in creating the trip route map.

17. A server as recited in claim 11, wherein the computer is configured to allow the user to edit the trip route information through a graphical user interface.
